(19) United States
(12) Patent Application Publication
(10) Pub. No.: US 2022/0317771 A1
(43) Pub. Date: Oct. 6, 2022

(54) METHOD FOR TRACKING TRACKERS AND HOST

(71) Applicant: HTC Corporation, Taoyuan City (TW)

(72) Inventors: Chih Chien Chen, Taoyuan City (TW); Chun-Kai Huang, Taoyuan City (TW); Po-Yu Lin, Taoyuan City (TW)

(73) Assignee: HTC Corporation, Taoyuan City (TW)

(21) Appl. No.: 17/695,798

(22) Filed: Mar. 15, 2022

Related U.S. Application Data
(60) Provisional application No. 63/169,257, filed on Apr. 1, 2021.

(51) Int. Cl. G06F 3/01; G06T 7/77

(52) U.S. Cl. CPC G06F 3/014; G06F 3/012; G06F 3/017; G06T 7/77

(57) ABSTRACT

The embodiments of the disclosure provide a method for tracking trackers and a host. The method includes: obtaining a first relative pose between a first tracker and a second tracker; in response to determining that the first relative pose is stable, determining whether a first pose of the first tracker is trackable; and in response to determining that the first pose of the first tracker is untrackable, determining the first pose of the first tracker based on a second pose of the second tracker and the first relative pose.

### CROSS-REFERENCE TO RELATED APPLICATION

This application claims the priority benefit of U.S. provisional application Ser. No. 63/169,257, filed on Apr. 1, 2021. The entirety of the above-mentioned patent application is hereby incorporated by reference herein and made a part of this specification.

### BACKGROUND

### 1. Field of the Invention

The disclosure generally relates to a pose tracking mechanism, in particular, to a method for tracking trackers and a host.

### 2. Description of Related Art

In general, trackers are devices that can be tracked by position tracking system of reality systems (e.g., virtual reality (VR) systems). In various implementations, trackers may have different shapes or designs. For example, a VR handheld controller is one kind of trackers that have several LEDs installed thereon. Such trackers can be tracked using cameras on VR head-mounted display (HMD) or using lighthouse technology.

In one implementation, the LEDs on the VR handheld controller can be controlled to emit visible/invisible lights that collectively form a light distribution. This light distribution can be captured by the cameras on the VR HMD as image, and the VR HMD can track the pose of the VR handheld controller based on the light distribution captured in the image by using inside-out tracking mechanism (e.g., Perspective-n-Point (PnP) algorithms).

Nowadays, there is one kind of trackers can be attached to any to-be-tracked object, and hence this object can be tracked using trackers and VR techniques.

However, no matter for which kind of trackers, these trackers are tracked individually. In this case, when one tracker is untrackable (e.g., being occluded or out of the field of vision (FOV) of the HMD), the pose of the tracker or the corresponding to-be-tracked object would be unavailable as well.

### SUMMARY OF THE INVENTION

Accordingly, the disclosure is directed to a method for tracking trackers and a host, which may be used to solve the above technical problems.

The embodiments of the disclosure provide a method for tracking trackers, adapted to a host. The method includes: obtaining a first relative pose between a first tracker and a second tracker; in response to determining that the first relative pose is stable, determining whether a first pose of the first tracker is trackable; and in response to determining that the first pose of the first tracker is untrackable, determining the first pose of the first tracker based on a second pose of the second tracker and the first relative pose.

The embodiments of the disclosure provide a host including a storage circuit and a processor. The storage circuit stores a program code. The processor is coupled to the storage circuit and accesses the program code to perform: obtaining a first relative pose between a first tracker and a second tracker; in response to determining that the first relative pose is stable, determining whether a first pose of the first tracker is trackable; and in response to determining that the first pose of the first tracker is untrackable, determining the first pose of the first tracker based on a second pose of the second tracker and the first relative pose.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a tracking system according to an embodiment of the disclosure.

FIG. 2 shows a schematic diagram of a to-be-tracked object attached with trackers according to an embodiment of the disclosure.

FIG. 3 shows a flow chart of the method for tracking trackers according to an embodiment of the disclosure.

FIG. 4 shows a flow chart of the method of tracking the trackers according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

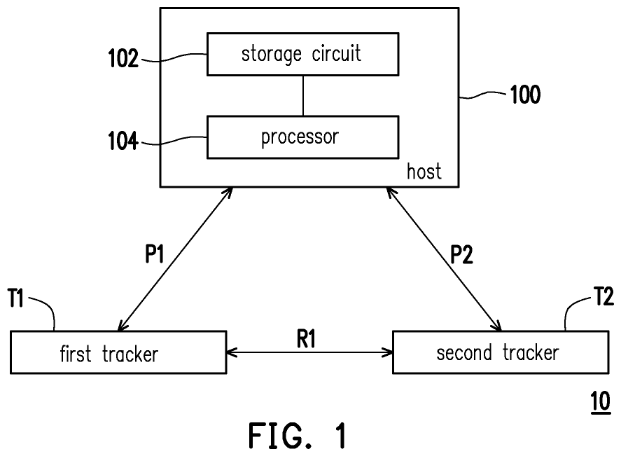

See FIG. 1, which shows a schematic diagram of a tracking system according to an embodiment of the disclosure. In FIG. 1, the tracking system 10 includes a host 100, a first tracker T1 and a second tracker T2. In some embodiments, the host 100 can be any device that is capable of tracking the first tracker T1 and the second tracker T2.

In FIG. 1, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In one embodiment, the host 100 can track a first pose P1 of the first tracker T1 and/or a second pose P2 of the second tracker T2 by performing any known tracking algorithms, such as inside-out tracking mechanism.

In one embodiment, the first tracker T1 is disposed with a plurality of first light emitting elements (e.g., LEDs) that can emit visible/invisible first lights. In one embodiment, the first lights collectively form a first light distribution, and a camera (e.g., a front camera) on the host 100 can capture images of the first light distribution and accordingly determine the first pose P1 of the first tracker T1.

In one embodiment, the second tracker T2 is disposed with a plurality of second light emitting elements (e.g., LEDs) that can emit visible/invisible second lights. In one embodiment, the second lights collectively form a second light distribution, and a camera (e.g., a front camera) on the host 100 can capture images of the second light distribution and accordingly determine the second pose P2 of the second tracker T2.

In various embodiments, the first tracker T1 and/or the second tracker T2 can be implemented in different ways, such as VR handheld controllers, smart rings, smart bracelets or other devices that is/are trackable to the host 100. In one embodiment, the first tracker T1 and/or the second tracker T2 can be attached to one or more to-be-tracked objects, such that the host 100 can determine the pose of each to-be-tracked object based on the first pose P1 and the second pose P2, but the disclosure is not limited thereto.

In one embodiment, the first tracker T1 and the second tracker T2 can be attached to the same to-be-tracked object. In one embodiment, the to-be-tracked object can have a rigid body having specific positions for the first tracker T1 and the second tracker T2 to attach.

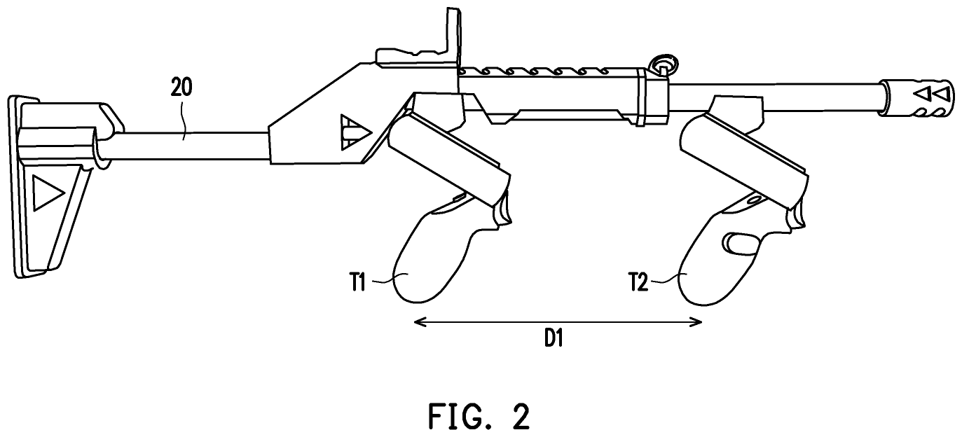

See FIG. 2, which shows a schematic diagram of a to-be-tracked object attached with trackers according to an embodiment of the disclosure. In FIG. 2, the to-be-tracked object 20 can be an object shaped like a rifle gun, wherein the first tracker T1 and the second tracker T2 can be attached/connected/mounted on specific positions on the body of the to-be-tracked object 20. In one embodiment, the specific positions where the first tracker T1 and the second tracker T2 are attached/connected/mounted can correspond to handles of a regular rifle gun. In this case, the user can use/operate the to-be-tracked object 20 like using a rifle gun by holding the first tracker T1 and the second tracker T2 with the hands of the user.

In other embodiments, the first tracker T1 and the second tracker T2 can be combined as a to-be-tracked object. For example, the first tracker T1 can be one half of the to-be-tracked object (e.g., a ball) and the second tracker T2 can be the other half of the to-be-tracked object. In this case, the first tracker T1 and the second tracker T2 can be disposed with corresponding engaging/assembling elements/portions for engaging/assembling the first tracker T1 and the second tracker T2 as the to-be-tracked object. Hence, the host 100 can track the pose of the to-be-tracked object (e.g., the ball) via tracking the first pose P1 and the second pose P2, but the disclosure is not limited thereto.

In various embodiments, the host 100 can be any device that is capable of performing tracking mechanisms. In one embodiment, the host 100 can be an HMD, and the first tracker T1 and the second tracker T2 can be trackers connected to and/or paired with the HMD. In other embodiments, the host 100 can be connected to and/or paired with other trackers for tracking the poses of the trackers, but the disclosure is not limited thereto.

In the embodiments of the disclosure, the processor 104 may access the modules stored in the storage circuit 102 to implement the method for dynamically showing a virtual boundary provided in the disclosure, which would be further discussed in the following.

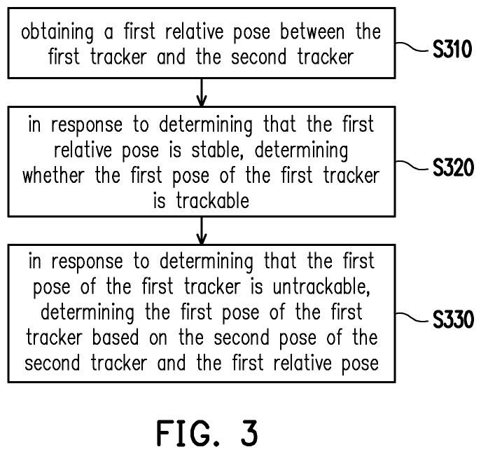

See FIG. 3, which shows a flow chart of the method for tracking trackers according to an embodiment of the disclosure. The method of this embodiment may be executed by the host 100 in FIG. 1, and the details of each step in FIG. 3 will be described below with the components shown in FIG. 1.

In step S310, the processor 104 obtains a first relative pose R1 between the first tracker T1 and the second tracker T2. In one embodiment, when the first pose P1 of the first tracker T1 and the second pose P2 of the second tracker T2 are trackable/available, the processor 104 can obtain the first relative pose R1 based on the first pose P1 and the second pose P2. In one embodiment, the processor 104 can obtain the first relative pose R1 based on a pose difference between the first pose P1 and the second pose P2.

In one embodiment, once the first relative pose R1 is obtained, one of the first pose P1 and the second pose P2 can be characterized by the first relative pose R1 and the other of the first pose P1 and the second pose P2. For example, after obtaining the first relative pose R1, the processor 104 can obtain the first pose P1 based on the second pose P2 and the first relative pose R1 or obtain the second pose P2 based on the first pose P1 and the first relative pose R1.

For example, in the scenario in FIG. 2, the orientation of the first tracker T1 is assumed to be the same as the orientation of the second tracker T2, and the second tracker T2 is assumed to be distant from the first tracker T1 by a distance D1 on a first direction. In this case, the first relative pose R1 can be regarded as the second tracker T2 being distant from the first tracker T1 by the distance D1 on the first direction or regarded as the first tracker T1 being distant from the second tracker T2 by the distance D1 on a second direction, wherein the second direction is opposite to the first direction, but the disclosure is not limited thereto.

In this case, when the first pose P1 of the first tracker T1 is obtained, the second pose P2 can be characterized by shifting the first pose P1 along the first direction by the distance D1. Similarly, when the second pose P2 of the second tracker T2 is obtained, the first pose P1 can be characterized by shifting the second pose P2 along the second direction by the distance D1, but the disclosure is not limited thereto.

In one embodiment, the processor 104 can determine whether the first relative pose R1 is stable. In one embodiment, the processor 104 can determine whether the first relative pose R1 has been (substantially) maintained and/or unchanged for a predetermined time length when during determining whether the first relative pose R1 is stable. In one embodiment, in response to determining that the first relative pose R1 has been (substantially) maintained and/or unchanged for the predetermined time length, the processor 104 determines that the first relative pose R1 is stable. In one embodiment, when determining that the first relative pose R1 is stable, it may represent that the first tracker T1 and the second tracker T2 have been attached/mounted to the same to-be-tracked object having a rigid body (e.g., the case shown in FIG. 2), but the disclosure is not limited thereto.

In one embodiment, the to-be-tracked object having a rigid body may be disposed with several sensors for detecting whether the first tracker T1 and the second tracker T2 have been attached/mounted to specific positions on the rigid body. In one embodiment, in response to determining that a plurality of sensing signals of the sensors fixed on the rigid body indicate that the first tracker T1 and the second tracker T2 have been attached to the specific positions on the rigid body, the processor 104 can determine that the first relative pose R1 is stable.

Taking FIG. 2 as an example, the specific positions where the first tracker T1 and the second tracker T2 are attached/mounted/connected to the rigid body of the to-be-tracked object 20 can be disposed with sensors for detecting whether the first tracker T1 and the second tracker T2 have been attached/mounted to specific positions on the rigid body, but the disclosure is not limited thereto.

In one embodiment, the first relative pose R1 can be pre-given. Taking FIG. 2 as an example, the first relative pose R1 can be pre-designed when designing the structure of the to-be-tracked object 20. In this case, once the first tracker T1 and the second tracker T2 are attached/mounted/connected to the specific positions, the first relative pose R1 can be regarded as known and stable. In one embodiment, the host 100 can provide a specific button in the visual content seen by the user, wherein the specific button can be used to inform the host 100 that the first tracker T1 and the second tracker T2 have been attached/mounted/connected to the specific positions on the to-be-tracked object. In this case, after the first tracker T1 and the second tracker T2 have been attached/mounted/connected to the specific positions on the to-be-tracked object, the user may trigger the specific button to generate a control signal for informing the host 100, and the host 100 can determine that the first relative pose R1 is stable since the first relative pose R1 can be pre-given, but the disclosure is not limited thereto.

In step S320, in response to determining that the first relative pose R1 is stable, the processor 104 determines whether the first pose P1 of the first tracker T1 is trackable.

In one embodiment, during the processor 104 determining whether the first pose P1 of the first tracker T1 is trackable, the processor 104 can determine whether the first light distribution is sufficient for tracking the first pose P1 of the first tracker T1. In one embodiment, in response to determining that the first light distribution is not sufficient for tracking the first pose P1 of the first tracker T1, the processor 104 can determine that the first pose P1 of the first tracker T1 is untrackable. On the other hand, in response to determining that the first light distribution is sufficient for tracking the first pose P1 of the first tracker T1, the processor 104 can determine that the first pose P1 of the first tracker T1 is trackable. In the embodiments of the disclosure, whether the first light distribution is sufficient for tracking the first pose P1 can be determined based on the tracking mechanism used by the processor 104.

In one embodiment, in response to determining that the first tracker T1 is occluded for over a specific proportion of a body of the first tracker T1, the processor 104 can determine that the first pose P1 of the first tracker Ti is untrackable. That is, when the first tracker T1 is occluded by too much, the processor 104 can determine that the first pose P1 of the first tracker T1 is untrackable. On the other hand, in response to determining that the first tracker T1 is occluded for less than the specific proportion of the body of the first tracker T1, the processor 104 can determine that the first pose P1 of the first tracker T1 is trackable. That is, when the first tracker T1 is not occluded by too much, the processor 104 can determine that the first pose P1 of the first tracker T1 is trackable, but the disclosure is not limited thereto.

In one embodiment, the processor 104 can also determine whether the second tracker is trackable in response to determining that the first relative pose R1 is stable.

In one embodiment, during the processor 104 determining whether the second pose P2 of the second tracker T2 is trackable, the processor 104 can determine whether the second light distribution is sufficient for tracking the second pose P2 of the second tracker T2. In one embodiment, in response to determining that the second light distribution is not sufficient for tracking the second pose P2 of the second tracker T2, the processor 104 can determine that the second pose P2 of the second tracker T2 is untrackable. On the other hand, in response to determining that the second light distribution is sufficient for tracking the second pose P2 of the second tracker T2, the processor 104 can determine that the second pose P2 of the second tracker T2 is trackable. In the embodiments of the disclosure, whether the second light distribution is sufficient for tracking the second pose P2 can be determined based on the tracking mechanism used by the processor 104.

In one embodiment, in response to determining that the second tracker T2 is occluded for over a specific proportion of a body of the second tracker T2, the processor 104 can determine that the second pose P2 of the second tracker T2 is untrackable. That is, when the second tracker T2 is occluded by too much, the processor 104 can determine that the second pose P2 of the second tracker T2 is untrackable. On the other hand, in response to determining that the second tracker T2 is occluded for less than the specific proportion of the body of the second tracker T2, the processor 104 can determine that the second pose P2 of the second tracker T2 is trackable. That is, when the second tracker T2 is not occluded by too much, the processor 104 can determine that the second pose P2 of the second tracker T2 is trackable, but the disclosure is not limited thereto.

In step S330, in response to determining that the first pose P1 of the first tracker T1 is untrackable, the processor 104 determines the first pose P1 of the first tracker T1 based on the second pose P2 of the second tracker T2 and the first relative pose R1.

In one embodiment, in response to determining that the first pose P1 of the first tracker T1 is untrackable but the second pose P2 of the second tracker T2 is trackable (e.g., the first tracker T1 is occluded but the second tracker T2 is visible to the host 100), the processor 104 determines the first pose P1 of the first tracker T1 based on the second pose P2 of the second tracker T2 and the first relative pose R1. In one embodiment, the processor 104 can combine the second pose P2 of the second tracker T2 and the first relative pose R1 into the first pose P1 of the first tracker T1.

In particular, as mentioned in the above, the first pose P1 can be characterized by the second pose P2 and the first relative pose R1, the processor 104 can determine/estimate the first pose P1 based on the second pose P2 and the first relative pose R1 when the first tracker Ti is untrackable.

Taking FIG. 2 as an example, when the first tracker T1 is untrackable, the processor 104 can determine/estimate the first pose P1 by shifting the second pose P2 along the second direction by the distance D1, but the disclosure is not limited thereto.

In another embodiment, in response to determining that the first pose P1 of the first tracker T1 is trackable but the second pose P2 of the second tracker T2 is untrackable (e.g., the first tracker T1 is visible but the second tracker T2 is occluded to the host 100), the processor 104 determines the second pose P2 of the second tracker T2 based on the first pose P1 of the first tracker T1 and the first relative pose R1. In one embodiment, the processor 104 can combine the first pose P1 of the first tracker T1 and the first relative pose R1 into the second pose P2 of the second tracker T2.

In particular, as mentioned in the above, since the second pose P2 can be characterized by the first pose P1 and the first relative pose R1, the processor 104 can determine/estimate the second pose P2 based on the first pose P1 and the first relative pose R1 when the second tracker T2 is untrackable.

Taking FIG. 2 as an example, when the second tracker T2 is untrackable, the processor 104 can determine/estimate the second pose P2 by shifting the first pose P1 along the first direction by the distance D1, but the disclosure is not limited thereto.

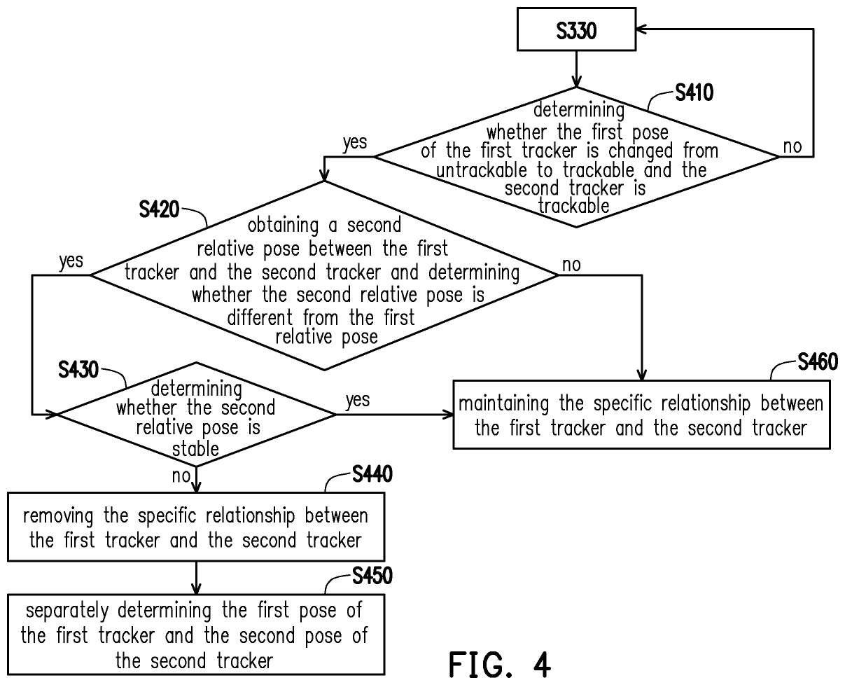

In one embodiment, in response to determining that the first relative pose R1 is stable, the processor 104 can establish a specific relationship between the first tracker T1 and the second tracker T2, wherein the specific relationship indicates that a relative pose between the first tracker T1 and the second tracker T2 is stable. In this case, the processor 104 can perform further operations based on the specific relationship, and the details thereof would be discussed with FIG. 4.

See FIG. 4, which shows a flow chart of the method of tracking the trackers according to an embodiment of the disclosure. In the embodiment, step S330 of FIG. 3, the processor 104 can perform step S410 to determine whether the first pose P1 of the first tracker T1 is changed from untrackable to trackable and the second tracker T2 is trackable.

In response to determining that the first pose P1 of the first tracker T1 is changed from untrackable to trackable and the second tracker P2 is trackable, the processor 104 can perform step S420 to obtain a second relative pose R2 between the first tracker T1 and the second tracker T2 and determine whether the second relative pose R2 is different from the first relative pose R1.

In one embodiment, in response to determining that the second relative pose R2 is different from the first relative pose R1, the processor 104 can perform step S430 to determine whether the second relative pose R2 is stable. In response to determining that the second relative pose R2 is not stable, the processor 104 can perform step S440 to remove the specific relationship between the first tracker T1 and the second tracker T2.

In one embodiment, in response to determining that the specific relationship between the first tracker T1 and the second tracker T2 has been removed, the processor 104 can perform step S450 to separately determine the first pose P1 of the first tracker T1 and the second pose P2 of the second tracker T2.

In one embodiment, in response to determining that the second relative pose R2 is stable, the processor 104 can perform step S460 to maintain the specific relationship between the first tracker T1 and the second tracker T2.

In one embodiment, in response to determining that the second relative pose R2 is not different from the first relative pose R1 in step S420, the processor 104 can perform step S460 to maintain the specific relationship between the first tracker T1 and the second tracker T2.

In one embodiment, in response to determining that the first pose P1 of the first tracker T1 is not changed from untrackable to trackable and the second tracker P2 is trackable, the processor 104 can perform step S330 for determining the first pose P1 of the first tracker T1.

That is, when the first tracker T1 and the second tracker T2 are both trackable after step S330, the processor 104 can determine whether the relative pose between the first tracker T1 and the second tracker T2 has changed. If the relative pose between the first tracker T1 and the second tracker T2 has not been changed, it represents that the pose of one of the first tracker T1 and the second tracker T2 can be still characterized by the first relative pose R1 and the pose of the other of the first tracker T1 and the second tracker T2, and hence the specific relationship between the first tracker T1 and the second tracker T2 can be maintained. In this case, if one of the first tracker T1 and the second tracker T2 is untrackable, the processor 104 can determine the pose of the untrackable tracker based on the first relative pose R1 and the pose of the other of the first tracker T1 and the second tracker T2. For example, in response to determining that the first pose P1 of the first tracker T1 becomes untrackable again and the second tracker T2 is trackable, the processor 104 can determine the first pose P1 of the first tracker T1 based on the second pose P2 of the second tracker T2 and the first relative pose R1.

On the other hand, if the relative pose between the first tracker T1 and the second tracker T2 has been changed to a stable second relative pose R2, it represents that the pose of one of the first tracker T1 and the second tracker T2 can be characterized by the second relative pose R2 and the pose of the other of the first tracker T1 and the second tracker T2, and hence the specific relationship between the first tracker T1 and the second tracker T2 can be maintained. In this case, if one of the first tracker T1 and the second tracker T2 is untrackable, the processor 104 can determine the pose of the untrackable tracker based on the second relative pose R2 and the pose of the other of the first tracker T1 and the second tracker T2. For example, in response to determining that the first pose P1 of the first tracker T1 becomes untrackable again and the second tracker T2 is trackable, the processor 104 can determine the first pose P1 of the first tracker T1 based on the second pose P2 of the second tracker T2 and the second relative pose R2.

However, if the relative pose between the first tracker T1 and the second tracker T2 has been changed to an unstable second relative pose R2, it represents that the pose of one of the first tracker T1 and the second tracker T2 cannot be characterized by the second relative pose R2 and the pose of the other of the first tracker T1 and the second tracker T2, and hence the specific relationship between the first tracker T1 and the second tracker T2 should be removed. In this case, the processor 104 can separately determine the poses of the first tracker T1 and the second tracker T2, i.e., performing tracking to the first tracker T1 and the second tracker T2 individually.

In one embodiment, in response to determining that the first pose P1 of the first tracker T1 and the second pose P2 of the second tracker T2 are trackable, the processor 104 can separately determine the first pose of the first pose P1 of the first tracker T1 and the second pose P2 of the second tracker T2, but the disclosure is not limited thereto.

In the embodiments where the host 100 is used to track more trackers, the relative pose between any two of the trackers can be obtained. In this case, when one or more of the trackers is/are untrackable, the processor 104 can determine the pose of each untrackable tracker based on the pose of another trackable tracker and the relative pose between the trackable tracker and each untrackable tracker, but the disclosure is not limited thereto.

In summary, the embodiments of the disclosure can determine the pose of one tracker based on the pose of another tracker and a stable relative pose between these trackers. In this case, when one tracker becomes untrackable (e.g., occluded), the pose of the untrackable tracker can be still determined based on the pose of another trackable tracker and the relative pose between the trackable tracker and the untrackable tracker. Accordingly, the tracking performance would be less affected by the issue of occlusion.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for tracking trackers, adapted to a host, comprising:
obtaining a first relative pose between a first tracker and a second tracker;
in response to determining that the first relative pose is stable, determining whether a first pose of the first tracker is trackable; and
in response to determining that the first pose of the first tracker is untrackable, determining the first pose of the first tracker based on a second pose of the second tracker and the first relative pose.

2. The method according to claim 1, wherein the step of obtaining the first relative pose between the first tracker and the second tracker comprises:
in response to determining that the first tracker and the second tracker are trackable, detecting the first pose of the first tracker and the second pose of the second tracker and accordingly obtaining the first relative pose between the first tracker and second tracker.

3. The method according to claim 1, further comprising:
in response to determining that the first relative pose between the first tracker and second tracker has been maintained for a predetermined time length, determining that the first relative pose between the first tracker and second tracker is stable.

4. The method according to claim 1, further comprising:
in response to determining that a plurality of sensing signals of a plurality of sensors fixed on a rigid body indicate that the first tracker and the second tracker have been attached to a plurality of specific positions on the rigid body, determining that the first relative pose between the first tracker and second tracker is stable.

5. The method according to claim 1, wherein the first relative pose between the first tracker and the second tracker is pre-given, and the method further comprises:
in response to determining that a control signal indicates that the first tracker and the second tracker have been attached to a plurality of specific positions on a rigid body, determining that the first relative pose between the first tracker and second tracker is stable.

6. The method according to claim 1, wherein first lights emitted by a plurality of first light emitting elements on the first tracker form a first light distribution, and the method further comprises:
in response to determining that the first light distribution is not sufficient for tracking the first pose of the first tracker, determining that the first pose of the first tracker is untrackable; and
in response to determining that the first light distribution is sufficient for tracking the first pose of the first tracker, determining that the first pose of the first tracker is trackable.

7. The method according to claim 6, further comprising:
capturing the first light distribution with a camera on the host as an image; and
tracking the first pose of the first tracker based on the first light distribution in the image.

8. The method according to claim 1, further comprising:
in response to determining that the first tracker is occluded for over a specific proportion of a body of the first tracker, determining that the first pose of the first tracker is untrackable; and
in response to determining that the first tracker is occluded for less than the specific proportion of the body of the first tracker, determining that the first pose of the first tracker is trackable.

9. The method according to claim 1, further comprising:
in response to determining that the first pose of the first tracker is untrackable but the second pose of the second tracker is trackable, determining the first pose of the first tracker based on the second pose of the second tracker and the first relative pose.

10. The method according to claim 9, wherein second lights emitted by a plurality of second light emitting elements on the second tracker form a second light distribution, and the method further comprises:
in response to determining that the second light distribution is not sufficient for tracking the second pose of the second tracker, determining that the second pose of the second tracker is untrackable; and
in response to determining that the second light distribution is sufficient for tracking the second pose of the second tracker, determining that the second pose of the second tracker is trackable.

11. The method according to claim 1, wherein the step of determining the first pose of the first tracker based on the second pose of the second tracker and the first relative pose comprises:
combining the second pose of the second tracker and the first relative pose into the first pose of the first tracker.

12. The method according to claim 1, wherein before the step of determining whether the first pose of the first tracker is trackable, the method further comprises:
establishing a specific relationship between the first tracker and the second tracker.

13. The method according to claim 12, further comprising:
in response to determining that the first pose of the first tracker is changed from untrackable to trackable and the second tracker is trackable, obtaining a second relative pose between the first tracker and the second tracker;
in response to determining that the second relative pose is different from the first relative pose, determining whether the second relative pose is stable; and
in response to determining that the second relative pose is not stable, removing the specific relationship between the first tracker and the second tracker.

14. The method according to claim 13, further comprising:
in response to determining that the specific relationship between the first tracker and the second tracker has been removed, separately determining the first pose of the first tracker and the second pose of the second tracker.

15. The method according to claim 14, further comprising:
in response to determining that the second relative pose is stable, maintaining the specific relationship between the first tracker and the second tracker.

16. The method according to claim 15, wherein after the step of maintaining the specific relationship between the first tracker and the second tracker, the method further comprises:
in response to determining that the first pose of the first tracker becomes untrackable again and the second tracker is trackable, determining the first pose of the first tracker based on the second pose of the second tracker and the second relative pose.

17. The method according to claim 1, further comprising:
in response to determining that the first pose of the first tracker is trackable but the second pose of the second tracker is untrackable, determining the second pose of the second tracker based on the first pose of the first tracker and the first relative pose.

18. The method according to claim 1, further comprising:
in response to determining that the first pose of the first tracker and the second pose of the second tracker are trackable, separately determining the first pose of the first tracker and the second pose of the second tracker.

19. The method according to claim 1, wherein the host is a head-mounted display used to track the first tracker and the second tracker.

20. A host, comprising:
a non-transitory storage circuit, storing a program code;
a processor, coupled to the storage circuit and accessing the program code to perform:
obtaining a first relative pose between a first tracker and a second tracker;
in response to determining that the first relative pose is stable, determining whether a first pose of the first tracker is trackable; and
in response to determining that the first pose of the first tracker is untrackable, determining the first pose of the first tracker based on a second pose of the second tracker and the first relative pose.
